(19) United States
(12) Patent Application Publication
(10) Pub. No.: US 2026/0038366 A1
(43) Pub. Date: Feb. 5, 2026

(54) CHARACTERIZING CONGESTION QUEUE STATUS ON ROAD LINKS

(71) Applicant: HERE Global B.V., Eindhoven (NL)

(72) Inventor: James Adeyemi FOWE, Chicago, IL (US)

(21) Appl. No.: 18/790,964

(22) Filed: Jul. 31, 2024

(51) Int. Cl. G08G 1/01

(52) U.S. Cl. CPC G08G 1/0133; G08G 1/0112; G08G 1/0137

(57) ABSTRACT

A system for characterizing congestion queue status on road links is disclosed. The system obtains the first probe data associated with a first plurality of probe points from a first vehicle of a set of vehicles associated with a road segment. The system further generates a plurality of motion components for each of the first plurality of probe points based on the obtained first data. The system further applies a machine learning (ML) model on the generated plurality of motion components for the first plurality of probe points. The system further generates a set of clusters based on the application of the ML model on the generated plurality of motion components. The system further outputs the generated set of clusters.

### TECHNOLOGICAL FIELD

The present disclosure generally relates to characterizing congestion queues and more particularly relates to a system and a method for characterizing congestion queue status on road links.

### BACKGROUND

Road traffic problems are a significant concern in urban areas worldwide. Congestion on roads leads to a variety of problems such as delays, increased pollution, and decreased productivity. Characterizing congestion queue status on road links involves assessing and monitoring traffic conditions to understand the formation and impact of queues on roadways. Despite advancements in technologies and data analytics for traffic management, transportation agencies face challenges in effectively detecting and mitigating bottlenecks, congestion, and queue formation in real-time. The lack of comprehensive methodologies to accurately determine queue spread, identify impact areas, and implement timely mitigation strategies hinders the efficient management of traffic flow. This poses a significant obstacle to optimizing road infrastructure and minimizing the adverse effects of congestion on travelers.

Traditional methods of monitoring and managing traffic often rely on manual observations or fixed sensors, which may provide real-time and comprehensive data on traffic conditions on a road link. Furthermore, traditional solutions can detect whether congestion is present on a road link. However, information about the status of congestion (enqueuing, stagnant, or dequeuing) is not provided by the traditional solutions. To address these challenges, there is a growing need for advanced technologies and data-driven approaches to accurately detect, analyze, and mitigate traffic congestion.

### BRIEF SUMMARY OF SOME EXAMPLE EMBODIMENTS

A system, a method, and a computer programmable product are provided for implementing the process for characterizing congestion queue status on road links.

In one aspect, a system for characterizing congestion queue status on road links is disclosed. The system includes a memory configured to store a computer-executable instruction and one or more processors coupled to the memory. The one or more processors are configured to obtain from a first vehicle of a set of vehicles associated with a road segment, first probe data associated with a first plurality of probe points. The one or more processors may be further configured to generate a plurality of motion components for each of the first plurality of probe points based on the obtained first probe data. The one or more processors may be further configured to generate a plurality of motion components for each of the first plurality of probe points based on the obtained first probe data. Further, the one or more processors may be configured to apply a machine learning (ML) model on the generated plurality of motion components for the first plurality of probe points. The one or more processors may be further configured to generate a set of clusters based on the application of the ML model on the generated plurality of motion components. Each probe point may be assigned within one cluster of the set of clusters. Further, the one or more processors may be configured to output the generated set of clusters.

In additional system embodiments, the one or more processors may be further configured to determine traffic congestion status on the road segment based on the generated set of clusters. Further, the one or more processors may be configured to output the determined traffic congestion status on the road segment.

In additional system embodiments, the determined traffic congestion status on the road segment corresponds to one of an enqueuing of a traffic congestion on the road segment, a dequeuing of the traffic congestion on the road segment, or stagnant traffic congestion on the road segment.

In additional system embodiments, the first probe data associated with each probe point of the first plurality of probe points includes speed information of the first vehicle at the corresponding probe point, location information of the first vehicle at the corresponding probe point, and timestamp associated with the corresponding probe point.

In additional system embodiments, the first vehicle may be associated with a first lane of a set of lanes within the road segment. The one or more processors may be further configured to determine traffic congestion status on the first lane based on the generated set of clusters. The one or more processors may be further configured to output the determined traffic congestion status on the first lane. The determined traffic congestion status on the first lane may correspond to one of an enqueuing of the traffic congestion on the first lane, a dequeuing of the traffic congestion on the first lane, or stagnant traffic congestion on the first lane.

In additional system embodiments, the one or more processors may be configured to receive, from a user device, an input associated with a count of the set of clusters. The one or more processors may be further configured to generate the set of clusters based on the application of the ML model on the generated plurality of motion components and the received input.

In additional system embodiments, the one or more processors may be configured to determine an average acceleration of a first set of vehicles of the set of vehicles within a first cluster of the set of clusters. Further, the one or more processors may be configured to determine a traffic congestion status in the first portion of the road segment based on the determined average acceleration. The determined traffic congestion status corresponds to one of an enqueuing of a traffic congestion in the first portion of the road segment, a dequeuing of the traffic congestion in the first portion of the road segment, or stagnant traffic congestion in the first portion of the road segment.

In additional system embodiments, the one or more processors may be configured to compare the determined average acceleration of the first set of vehicles with a first pre-defined threshold. The one or more processors may be further configured to determine the traffic congestion status in the first portion of the road segment based on the comparison.

In additional system embodiments, the one or more processors may be configured to estimate a first accelerator metric associated with the first vehicle based on the obtained first probe data. The one or more processors may be further configured to generate the plurality of motion components for the first plurality of probe points based on the obtained first probe data and the estimated first accelerator metric.

In additional system embodiments, the one or more processors may be configured to determine the first speed of the first vehicle at a first timestamp from the first probe data. The first timestamp may be associated with a first probe point of the plurality of probe points. The one or more processors may be further configured to determine a second speed of the first vehicle at a second timestamp from the first probe data. The second timestamp may be associated with a second probe point of the plurality of probe points. Further, the one or more processors may be configured to estimate the first accelerator metric associated with the first vehicle based on the determined first speed and the determined second speed.

In additional system embodiments, the first probe data may be captured using one or more sensors associated with the first vehicle. The one or more sensors include at least one of Global Navigation Satellite System (GNSS) sensor or a speed sensor.

In additional system embodiments, the one or more processors may be configured to store the first probe data and the generated set of clusters for the first probe data in one or more databases.

In another aspect, a method of characterizing congestion queue status on road links is disclosed. The method includes obtaining from the first vehicle of a set of vehicles associated with a road segment, first probe data associated with a first plurality of probe points. The method further includes generating a plurality of motion components for each of the first plurality of probe points based on the obtained first probe data. Further, the method includes applying a machine learning (ML) model on the generated plurality of motion components for the first plurality of probe points. The method further includes generating a set of clusters based on the application of the ML model on the generated plurality of motion components. Each probe point may be assigned within one cluster of the set of clusters. Further, the method includes outputting the generated set of clusters.

In additional method embodiments, the method includes determining traffic congestion status on the road segment based on the generated set of clusters. The method further includes outputting the determined traffic congestion status on the road segment.

In additional method embodiments, the determined traffic congestion status on the road segment corresponds to one of an enqueuing of a traffic congestion on the road segment, a dequeuing of the traffic congestion on the road segment, or stagnant traffic congestion on the road segment.

In additional method embodiments, the first probe data associated with each probe point of the first plurality of probe points includes speed information of the first vehicle at the corresponding probe point, location information of the first vehicle at the corresponding probe point, and timestamp associated with the corresponding probe point.

In additional method embodiments, the method includes receiving, from a user device, an input associated with a count of the set of clusters. The method further includes generating the set of clusters based on the application of the ML model on the generated plurality of motion components and the received input.

In additional method embodiments, the method includes determining an average acceleration of a first set of vehicles of the set of vehicles within a first cluster of the set of clusters. The method further includes determining a traffic congestion status in a first portion of the road segment based on the determined average acceleration. The determined traffic congestion status corresponds to one of an enqueuing of a traffic congestion in the first portion of the road segment, a dequeuing of the traffic congestion in the first portion of the road segment, or stagnant traffic congestion in the first portion of the road segment.

In additional method embodiments, the method includes determining traffic congestion status on a first lane based on the generated set of clusters. The first vehicle may be associated with the first lane of a set of lanes within the road segment. Further, the method includes outputting the determined traffic congestion status on the first lane. The determined traffic congestion status on the first lane corresponds to one of an enqueuing of the traffic congestion on the first lane, a dequeuing of the traffic congestion on the first lane, or stagnant traffic congestion on the first lane.

In yet another aspect, a computer program product comprising a non-transitory computer readable medium having stored thereon computer executable instructions which when executed by at least one processor, cause the processor to conduct operations for characterizing congestion queue status on road links. The operations include obtaining, from the first vehicle of a set of vehicles associated with a road segment, the first probe data associated with a first plurality of probe points. The operations further include generating a plurality of motion components for each of the first plurality of probe points based on the obtained first probe data. Further, the operations include applying a machine learning (ML) model on the generated plurality of motion components for the first plurality of probe points. The operations further include generating a set of clusters based on the application of the ML model on the generated plurality of motion components. Each probe point may be assigned within one cluster of the set of clusters. Further, the operations include outputting the generated set of clusters.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 is a diagram that illustrates a network environment for characterizing congestion queue status on road lanes, in accordance with an embodiment of the disclosure;

FIG. 2 illustrates a block diagram of the system of FIG. 1, in accordance with an embodiment of the disclosure;

FIG. 3 is a diagram that illustrates exemplary operations for characterizing congestion queue status on road links, in accordance with an embodiment of the disclosure;

FIG. 4 is a diagram that illustrates a scenario diagram depicting a set of clusters on a road segment, in accordance with an embodiment of the disclosure;

FIG. 5 is a diagram that illustrates a scenario depicting a set of clusters in a lane of a road segment, in accordance with an embodiment of the disclosure;

FIG. 6 is a flowchart that illustrates an exemplary method for characterizing congestion queue status on road links, in accordance with an embodiment of the disclosure;

FIG. 7 shows a first format of the map data stored in the map database, in accordance with an embodiment of the disclosure;

FIG. 8 shows a second format of the map data stored in the map database, in accordance with an embodiment of the disclosure; and

FIG. 9 illustrates a block diagram of the map database storing map data or geographic data in the form of road segments/links, nodes, and one or more associated attributes.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received, and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the description and should not be regarded as limiting. Any heading utilized within this description is for convenience only and has no legal or limiting effect.

Characterizing and displaying real-time traffic congestion status on a user's device may offer a solution to the issue of inefficient commuting caused by traffic congestion. By providing end-users with up-to-date information on traffic conditions, the disclosed system may help the user to make informed decisions about their routes, ultimately reducing travel time and enhancing overall efficiency. The end-users benefit from the ability to avoid congested areas, leading to improved fuel efficiency, reduced carbon emissions, and a more sustainable transportation experience. With access to real-time traffic updates, the end-users may optimize their travel plans, choose alternative routes, and make decisions that enhance their commuting experience. Overall, this disclosure may address the challenges posed by traffic congestion, promoting smoother traffic flow, reduced environmental impact, and safer journeys for users. Some exemplary use cases of the disclosed invention may be, for example, but are limited to, transportation planning, traffic forecasting, traffic data visualization, road incident management, traffic service providers, traffic engineering, and road intersection analytics.

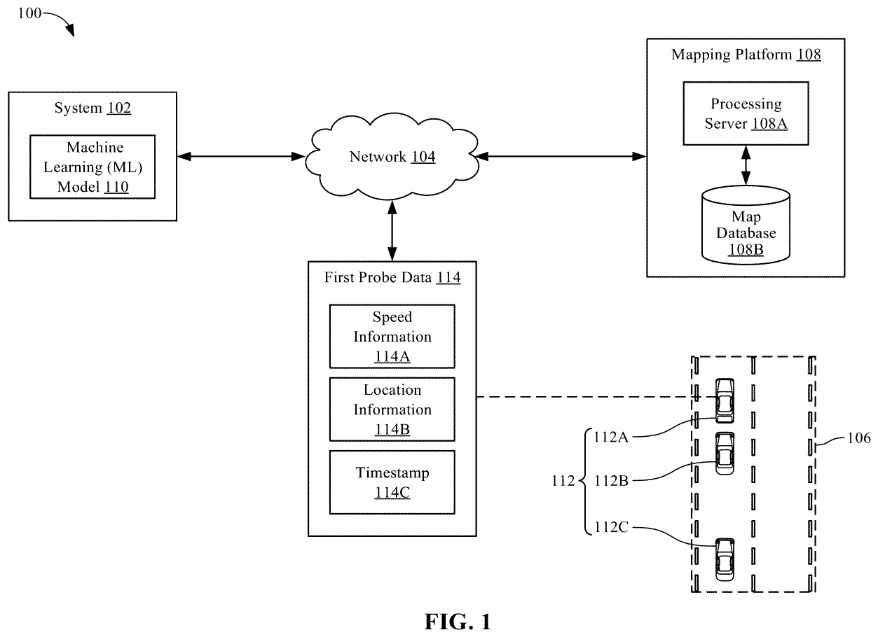

FIG. 1 is a diagram that illustrates a network environment 100 for characterizing congestion queue status on road links, in accordance with an embodiment of the disclosure. With reference to FIG. 1, there is shown a diagram of the network environment 100. The network environment 100 includes a system 102, a network 104, a road segment 106, and a mapping platform 108. The system 102 may further include a machine learning (ML) model 110. The road segment 106 may further include a set of lanes that may include a first lane 106A, a second lane 106B, a third lane 106C, and a fourth lane 106D. With reference to FIG. 1, there is further shown a set of vehicles 112 that may include a first vehicle 112A, a second vehicle 112B, and a third vehicle 112C. The mapping platform 108 may further include a processing server 108A, and a map database 108B. With reference to FIG. 1, there is further shown probe data 114 that may include speed information 114A, location information 114B, and timestamp 114C.

The system 102 may include suitable logic, circuitry, interfaces, and/or code that may be configured to characterize congestion queue status on road links (such as the road segment 106). The system 102 may be configured to obtain the first probe data 114 from the first vehicle 112A of the set of vehicles 112. The first probe data 114 may be captured using one or more sensors associated with the first vehicle 112A. Further, the one or more sensors may include at least one of a Global Navigation Satellite system (GNSS) sensor, or a speed sensor. The system 102 may be configured to estimate motion components, and further generate a set of clusters generation indicative of the traffic congestion on the road link. Examples of the system 102 may include, but are not limited to, an electronic control unit (ECU), an electronic control module (ECM), a computing device, a mainframe machine, a server, a computer workstation, any and/or any other device with safety distance determination operations.

In an example embodiment, the system 102 may be onboard the set of vehicles 112 such as the first vehicle 112A, the second vehicle 112B, and the third vehicle 112C. The system 102 may be a congestion queue determination system installed in each of the set of vehicles 112 for determining the congestion queue status on the road links. In another example embodiment, the system 102 may be the processing server 108A of the mapping platform 108 and therefore may be co-located with or within the mapping platform 108.

In another embodiment, the system 102 may be embodied as a cloud-based service, a cloud-based application, a cloud-based platform, a remote server-based service, a remote server-based application, a remote server-based platform, or a virtual computing system. In yet another example embodiment, the system 102 may be an OEM (Original Equipment Manufacturer) cloud. The OEM cloud may be configured to anonymize any data received by the system 102, such as from the set of features, before using the data for further processing, such as before sending the data to the set of ML model 110 (or to the map database 108B). For example, anonymization of the data may be done by the mapping platform 108.

In an example, the system 102 may be installed in the first vehicle 112A and may be configured to obtain first probe data 114 and traffic conditions on link segments and/or road segments using image-based sensors, i.e., image sensors installed in the corresponding vehicle. In an exemplary embodiment, the sensors associated with the first vehicle 112A of the set of vehicles 112 may capture the first probe data 114. Further, the first probe data 114 may be obtained by the system 102 to determine congestion queue status on a road segment 106 or road links.

Each vehicle of the set of vehicles 112 may be a non-autonomous vehicle, a semi-autonomous vehicle, or a fully autonomous vehicle, for example, as defined by National Highway Traffic Safety Administration (NHTSA). Examples of each of the set of vehicles 112 may include, but are not limited to, a two-wheeler vehicle, a three-wheeler vehicle, a four-wheeler vehicle, more than four-wheeler vehicle, a hybrid vehicle, or a vehicle with autonomous drive capability that uses one or more distinct renewable or non-renewable power sources. A vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. Each vehicle of the set of vehicles 112 may be a system through which an occupant (for example a rider) may travel from a start point to a destination point. Examples of the two-wheeler vehicle may include, but are not limited to, an electric two-wheeler, an internal combustion engine (ICE)-based two-wheeler, or a hybrid two-wheeler. Similarly, examples of the four-wheeler vehicle may include, but are not limited to, an electric car, an internal combustion engine (ICE)-based car, a fuel-cell-based car, a solar powered-car, or a hybrid car. It may be noted here that the four-wheeler diagram of the first vehicle 112A and each of the set of vehicles 112 are merely shown as examples in FIG. 1. The present disclosure may also be applicable to other structures, designs, or shapes of the first vehicle 112A and each of the sets of vehicles. The description of other types of the vehicle and respective structures, designs, or shapes has been omitted from the disclosure for the sake of brevity.

In some example embodiments, the first vehicle 112A and each of the set of vehicles 112 may include processing means such as a central processing unit (CPU), storage means such as on-board read-only memory (ROM), and random access memory (RAM), acoustic sensors such as a microphone array, position sensors such as a global positioning system (GPS) sensor, gyroscope, a light detection and ranging (LiDAR) sensor, a proximity sensor, motion sensors such as an accelerometer, an image sensor such as a camera, a display enabled user interface such as a touch screen display, and other components as may be required for specific functionalities of the first vehicle 112A and each of the set of vehicles. In some example embodiments, the system 102 may be associated, coupled, or otherwise integrated with the vehicles, such as an advanced driver assistance system (ADAS), a personal navigation device (PND), a portable navigation device, the infotainment system, and/or other devices that may be configured to provide route guidance and navigation-related functions to the user.

In some example embodiments, each of the set of vehicles 112 may generate (or capture) probe data that may include the speed information 114A, the location information 114B, and the timestamp 114C associated with the respective vehicle. For example, the first vehicle 112A associated with the set of vehicles 112 may generate the first probe data 114 that may include the speed information 114A of the first vehicle 112A, the location information 114B, and the timestamp 114C associated with the first probe data 114 of the first vehicle 112A. In accordance with an embodiment, the first vehicle 112A or the set of vehicles 112 may generate the first probe data 114 in real-time and transmit it to the system 102 to determine the congestion queue status on the road links. In certain cases, the first vehicle 112A and each of the set of vehicles 112 may be configured to send updated the first probe data 114 periodically, for example, every five seconds, every thirty seconds, every minute, and so forth.

The mapping platform 108 may comprise suitable logic, circuitry, and interfaces that may be configured to store one or more map attributes and the first probe data 114 associated with traffic on link segments and lane segments. The mapping platform 108 may be configured to store and update map data indicating the traffic data along with other map attributes, road attributes, and traffic entities, in the map database 108B. The mapping platform 108 may include techniques related to, but not limited to, geocoding, routing (multimodal, intermodal, and unimodal), clustering algorithms, machine learning in location-based solutions, natural language processing algorithms, and artificial intelligence algorithms. Data for different modules of the mapping platform 108 may be collected using a plurality of technologies including, but not limited to drones, sensors, connected cars, cameras, probes, and chipsets. In some embodiments, the mapping platform 108 may be embodied as a chip or chip set. In other words, the mapping platform 108 may comprise one or more physical packages (such as chips) that include materials, components, and/or wires on a structural assembly (such as a baseboard).

In some example embodiments, the mapping platform 108 may include the processing server 108A for conducting the processing functions associated with the mapping platform 108 and the map database 108B for storing map data. In an embodiment, the processing server 108A may include one or more processors configured to process requests received from the system 102. The one or more processors may receive the first probe data 114 and/or map data from the map database 108B and transmit the same to the system 102 in a format suitable for use by the system 102.

Continuing further, the map database 108B may comprise suitable logic, circuitry, and interfaces that may be configured to store the first probe data 114 and map data, which may be collected from the mage sensor and/or the first vehicle 112A and/or the set of vehicles 112 traveling on a lane segment of the road segment 106, or in a region close to the lane segment. In accordance with an embodiment, such as the first probe data 114 may be updated in real-time or near real-time such as within a few seconds, a few minutes, or on an hourly basis, to provide accurate and up to date the first probe data 114. The first probe data 114 may be collected from any sensor that may inform the mapping platform 108 or the map database 108B of features within an environment that is appropriate for traffic-related services. In accordance with an embodiment, the first probe data 114 may be collected from any sensor that may inform the mapping platform 108 or the map database 108B of features within an environment that is appropriate for mapping. For example, motion sensors, inertia sensors, image capture sensors, proximity sensors, LiDAR sensors, and ultrasonic sensors may be used to collect the first probe data 114. The gathering of enormous quantities of crowd-sourced data may facilitate the accurate modeling and mapping of an environment, whether it is a road link or a link within a structure, such as in an interior of a multi-level parking structure.

The map database 108B may further be configured to store the traffic-related data and road topology and geometry-related data for a road network as map data. The map data may also include cartographic data, routing data, and maneuvering data. The map data may also include, but is not limited to, locations of intersections, diversions to be caused due to accidents, congestions or constructions, suggested roads, or links to avoid, and an estimated time of arrival (ETA) depending on different links. In accordance with an embodiment, the map database 108B may be configured to receive the map data including the road topology and geometry-related attributes related to the road network from external systems, such as one or more of background batch data services, streaming data services, and third-party service providers, via the network 104.

In accordance with an embodiment, the map data stored in the map database 108B may further include data about changes in traffic situations registered by GPS provider(s), such as, but not limited to, incidents, road repairs, heavy rains, snow, fog, time of day, day of a week, holiday or other events which may influence the traffic condition of a link segment.

In some embodiments, the map database 108B may further store historical probe data for events (such as, but not limited to, traffic incidents, construction activities, scheduled events, and unscheduled events) associated with Point of Interest (POI) data records or other records of the map database 108B.

For example, the data stored in the map database 108B may be compiled (such as into a platform specification format (PSF)) to organize and/or processed for generating navigation-related functions and/or services, such as route calculation, route guidance, map display, speed calculation, distance and travel time functions, navigation instruction generation, and other functions, by a navigation device, such as a user equipment. The navigation-related functions may correspond to vehicle navigation, pedestrian navigation, navigation to a favored parking spot, or other types of navigation. While example embodiments described herein generally relate to vehicular travel, example embodiments may be implemented for bicycle travel along bike paths, boat travel along maritime navigational routes, etc. The compilation to produce the end-user databases may be performed by a party or entity separate from the map developer. For example, a customer of the map developer, such as a navigation device developer or other end user device developer, may perform compilation on the received map database 108B in a delivery format to produce one or more compiled navigation databases.

In some embodiments, the map database 108B may be a master geographic database configured on the side of the system 102. In accordance with an embodiment, a client-side map database may represent a compiled navigation database that may be used in or with end-user devices to provide navigation instructions based on the traffic data, the traffic conditions, speed adjustment, ETAs, and/or map-related functions to navigate through the intersection connected links on the route.

In some embodiments, the map data may be collected by end-user vehicles (such as the first vehicle 112A of the set of vehicles 112) which use vehicles on-board one or more sensors to detect data about various entities such as road objects, lane markings, links, and the like. These vehicles are also referred to as probe vehicles and form an alternate form of data source for map data collection, along with ground truth data. Additionally, data collection mechanisms like remote sensing, such as aerial or satellite photography may be used to collect the map data for the map database 108B.

For example, the map database 108B may include lane and intersection data records or other data that may represent a link in the route, pedestrian lane, or areas in addition to or instead of the vehicle lanes. The lanes and intersections may be associated with attributes, such as geographic coordinates, street names, lane identifiers, lane segment identifiers, lane traffic direction, address ranges, speed limits, turn restrictions at intersections, and other navigation-related attributes, as well as POIs, such as fueling stations, hotels, restaurants, museums, stadiums, offices, auto repair shops, buildings, stores, and parks. The map database 108B may additionally include data about places, such as cities, towns, or other communities, and other geographic features such as, but not limited to, bodies of water, and mountain ranges.

In some example embodiments, images received from the image source may be stored within the map database 108B of the mapping platform 108. In certain cases, the mapping platform 108, using the processing server 108A, may suitably process the received images. For example, such processing may include suitably labeling the images based on the corresponding associated lane and/or link, point of interest within the link and/or lane, and other information relating to the respective link and/or lane. Such labeled images may then be stored within the map database 108B as map data.

The ML model 110 may include electronic data, such as, for example, a software program, code of the software program, libraries, applications, scripts, or other logic or instructions for execution by a processing device, such as the system 102. The ML model 110 may include code and routines configured to enable a computing device, such as the system 102 to perform one or more operations for characterizing the congestion queue on the road links. The application of the ML model 110 on the plurality of probe points may generate the set of clusters. Additionally, or alternatively, ML model 110 may be implemented using hardware including a processor, a microprocessor (e.g., to perform or control the performance of one or more operations), a field-programmable gate array (FPGA), or an application-specific integrated circuit (ASIC). Alternatively, in some embodiments, the ML model 110 may be implemented using a combination of hardware and software.

The system 102 may be communicatively coupled to each vehicle of the set of vehicles 112. and the mapping platform 108, via the network 104. In an embodiment, the system 102 may be communicatively coupled to other components not shown in FIG. 1 via the network 104. All the components in the network environment 100 may be coupled directly or indirectly to the network 104. The components described in the network environment 100 may be further broken down into more than one component and/or combined together in any suitable arrangement. Further, one or more components may be rearranged, changed, added, and/or removed.

The network 104 may be wired, wireless, or any combination of wired and wireless communication networks, such as cellular, Wi-Fi, internet, local area networks, or the like. In some embodiments, the network 104 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In operation, the system 102 may be configured to obtain the first probe data 114 associated with a first plurality of probe points from the first vehicle 112A of the set of vehicles 112 traveling on the road segment 106. Each probe point of the plurality of probe points may refer to specific locations from where the data or information associated with the set of vehicles 112 may be extracted for analysis. In the context of traffic analysis, the probe points may refer to specific locations along the road segment 106 where the first probe data 114 may be collected to analyze traffic flow and congestion. The first probe data 114 may include various measurements, such as the speed information 114A, the location information 114B, and timestamp 114C associated with the first vehicle 112A of the set of vehicles 112 that may be used to analyze traffic conditions.

In an exemplary embodiment, the speed information 114A associated with the first vehicle 112A may correspond to the speed of the first vehicle 112A when the first probe data 114 may be captured. The speed information 114A may be determined using speed sensors integrated within the first vehicle 112A. Such speed sensors may be, for example, but are not limited to, magneto-resistive sensors, bipolar sensors, monopolar sensors, and mechanical speed sensors. In another embodiment, the speed information 114A of the first vehicle 112A may be further determined by using radar guns, stopwatches, and GPS tracking devices. For instance, in the context of Intelligent Speed Assistance (ISA) systems, speed information 114A capture may be crucial for ensuring that the system may accurately determine the current speed limit and alert or prevent drivers from exceeding it.

In another exemplary embodiment, the location information 114B associated with the first vehicle 112A may correspond to the longitude and latitude of the first vehicle 112A when the first probe data 114 may be captured. In yet another embodiment, the timestamp 114C may include a timestamp at which the first probe data 114 was captured. The timestamp 114C may include, but is not limited to, the time of day when the first probe data 114 may be captured.

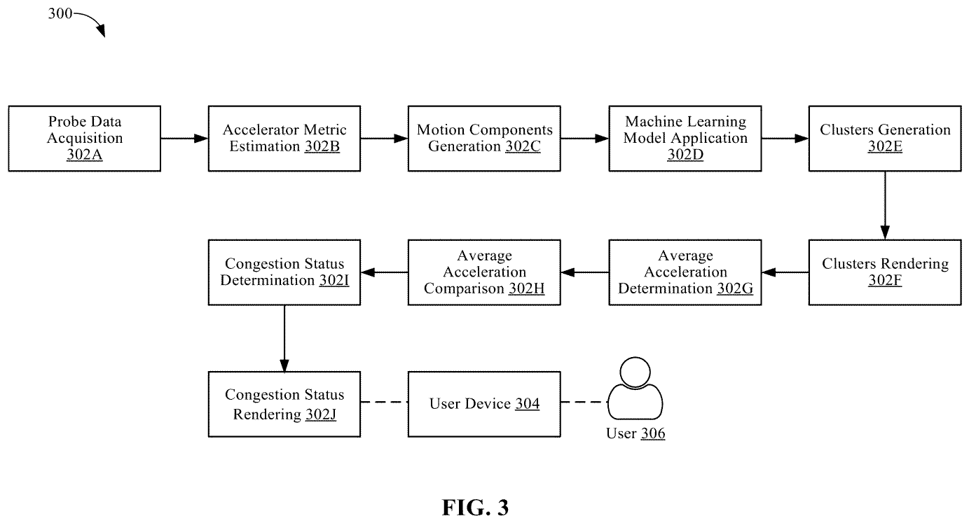

Further, the system 102 may be configured to generate a plurality of motion components for each of the first plurality of probe points based on the obtained first probe data 114. The motion components may include various measurements, such as speed, acceleration, and position associated with each of the set of vehicles 112, that may be used to analyze traffic conditions. The position may include the longitude and latitude of the vehicle at a given timestamp. By generating the motion component for each of the plurality of probe points, the system 102 may be able to analyze traffic conditions with greater accuracy. Details about the motion components are provided, for example, in FIG. 3.

In an embodiment, the system 102 may be further configured to apply the ML model 110 on the generated plurality of motion components. Further, the system 102 may be configured to generate a set of clusters based on the application of the ML model 110 on the generated plurality of motion components. Each probe point of the plurality of probe points may be assigned within one cluster of the set of clusters using a clustering technique implemented by the ML model 110. The clustering technique may be used to group similar data points together, may be useful in identifying patterns and trends in large datasets. By generating the set of clusters based on the application of the ML model 110 on the generated motion components, the system 102 may identify groups of the probe points that may have similar motion components, which may further indicate similar traffic conditions on the road links.

Further, the system 102 may be configured to output the generated set of clusters. The generated set of clusters may be used for further analysis and decision-making, such as identifying areas of congestion. By outputting the generated set of clusters, the system 102 may provide actionable insights that can be used to improve traffic flow and reduce congestion on the road segment. Further, the system 102 may be configured to store the first probe data 114 and the generated set of clusters for the first probe data 114 in one or more databases.

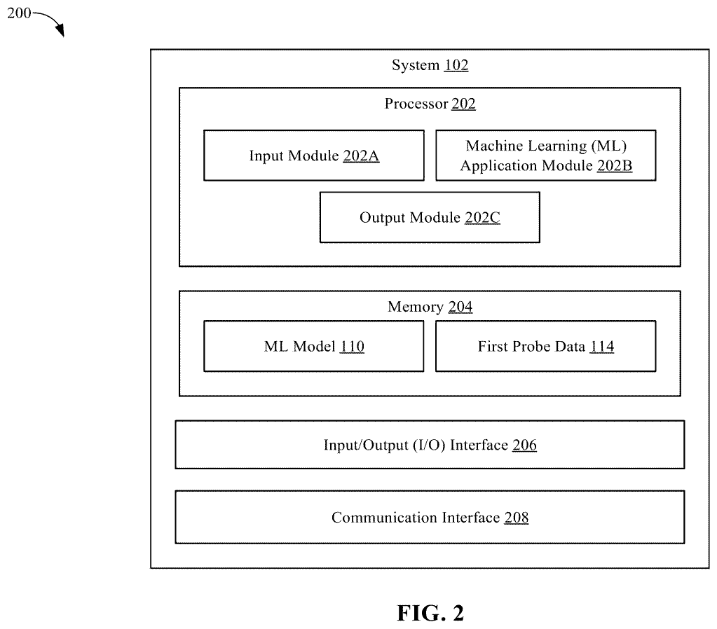

FIG. 2 illustrates a block diagram 200 of the system of FIG. 1, in accordance with an embodiment of the disclosure. FIG. 2 is explained in conjunction with FIG. 1. In FIG. 2, there is shown the block diagram 200 of the system 102. The system 102 may include at least one processor 202 (referred to as a processor 202, hereinafter), at least one non-transitory memory 204 (referred to as a memory 204, hereinafter), an input/output (I/O) interface 206, and a communication interface 208. The processor 202 may comprise modules, depicted as, an input module 202A, an ML application module 202B, and an output module 202C. The processor 202 may be connected to the memory 204, and the I/O interface 206 through wired or wireless connections. Although in FIG. 2, it is shown that the system 102 includes the processor 202, the memory 204, and the I/O interface 206 however, the disclosure may not be so limiting and the system 102 may include fewer or more components to perform the same or other functions of the system 102. In an embodiment, the input module 202A, and the output module 202C may be integrated within the I/O interface 206. In some embodiments, the input module 202A may receive input data (such as user inputs) and the output module 202C may output processed data (such as the set of clusters, congestion queue status, and the like) via the I/O interface 206.

In accordance with an embodiment, the system 102 may store data that may be generated by the modules while performing corresponding operations or may be retrieved from a database associated with the system 102, such as the map database 108B, in the memory 204. For example, the data may include vehicle information, traffic information, user information, distance information, and environmental information.

The processor 202 of the system 102 may be configured to obtain the first probe data 114, generate the plurality of motion components, apply the machine learning model, generate a set of clusters, and output the generated set of clusters. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as 100 may be accessed using the communication interface 208 of the system 102. The communication interface 208 may provide an interface for accessing various features and data stored in the system 102.

In some embodiments, the processor 202 may be configured to provide Internet-of-Things (IoT) related capabilities to users of the system 102 disclosed herein. The IoT-related capabilities may in turn be used to provide smart city solutions by providing real-time safety distance, real-time warnings, big data analysis, and sensor-based data collection by using the cloud-based mapping system for providing accurate navigation instructions and ensuring driver safety. The I/O interface 206 may provide an interface for accessing various features and data stored in the system 102.

The input module 202A of the processor 202 may be configured to obtain the first probe data 114 from the first vehicle 112A of the set of vehicles 112 travelling on the road segment 106. In an embodiment, the first probe data 114 may be obtained from the one or more sensors associated with the first vehicle 112A. In another example, the one or more sensors may be installed in the vicinity of link segments of the road segment 106 to obtain the first probe data 114. For example, the one or more sensors may include one or more image sensors, one or more LIDARs, one or more speed sensors, one or more global positioning sensors (GPS), Global Navigation Satellite System (GNSS) sensor, or a speed sensor and the like.

The ML application module 202B of the processor 202 may be configured to apply the ML model 110 on the generated motion components. The obtained first probe data 114 may be associated with information associated with the first vehicle 112A. In an exemplary embodiment, the first probe data 114 may include the speed information 114A, the location information 114B, and the timestamp 114C at which the first probe data 114 may be acquired.

The output module 202C of the processor 202 may be configured to output at least the generated set of clusters. Further, the output module 202C may be configured to output the determined traffic congestion status on the road segment 106. The determined traffic congestion status may be, for example, enqueuing of the traffic congestion on the road segment 106, dequeuing of the traffic congestion on the road segment 106, and stagnant traffic congestion on the road segment 106. In an embodiment, the output module 202C of the processor 202 may be further configured to output the determined traffic congestion on a first lane of the set of lanes within the road segment 106. The traffic congestion status may correspond to an enqueuing of the traffic congestion on the first lane 106A of the set of lanes, a dequeuing of the traffic congestion of the first lane 106A of the set of lanes, or the stagnant traffic congestion of the first lane 106A of the set of lanes.

The memory 204 of the system 102 may be configured to store the ML model 110 and the first probe data 114. The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to conduct various functions in accordance with an example embodiment of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured hardware for conducting the operations described herein.

In an embodiment, the first probe data 114 associated with each probe point of the first plurality of probe points may include, for example, but not limited to, the speed information 114A of the first vehicle 112A at the corresponding probe point, the location information 114B of the first vehicle 112A at the corresponding probe point, and the timestamp 114C associated with the corresponding probe point. The timestamp 114C associated with the corresponding probe point may indicate the specific time at which the first probe data 114 may be collected or recorded at the location specified in the location information. The timestamp 114C may provide temporal context to the data associated with the probe point, allowing for analysis of traffic conditions, speed variations, and congestion patterns over time.

In some example embodiments, the I/O interface 206 may communicate with the system 102 and display the input and/or output of the system 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the system 102 may include a user interface circuitry configured to control at least some functions of one or more I/O interface elements such as a display and, in some embodiments, a plurality of speakers, a ringer, one or more microphones and/or the like. The processor 202 and/or I/O interface 206 circuitry comprising the processor 202 may be configured to control one or more functions of one or more I/O interface 206 elements through computer program instructions (for example, software and/or firmware) stored on a memory 204 accessible to the processor 202. The processor 202 may further render notifications associated with the navigation instructions, such as traffic data, traffic conditions, traffic congestion value, ETA, routing information, road conditions, driving instructions, etc., on the user equipment or audio or display onboard the vehicles via the I/O interface 206.

The communication interface 208 may comprise the input interface and output interface for supporting communications to and from the system 102 or any other component with which the system 102 may communicate. The communication interface 208 may be any means such as a device or circuitry embodied in either hardware or a combination of hardware and software that is configured to receive and/or transmit data to/from a communications device in communication with the system 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to manage receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms. In some embodiments, the communication interface 208 may enable communication with a cloud-based network to enable deep learning, such as using the set of ML models 110 (that may be hosted on the cloud-based network).

FIG. 3 is a diagram 300 that illustrates exemplary operations for characterizing congestion queue status on road links, in accordance with an embodiment of the disclosure. FIG. 3 is explained in conjunction with elements from FIG. 1 and FIG. 2. With reference to FIG. 3, there is shown the block diagram 300 that illustrates exemplary operations from 302A to 302J, as described herein. The exemplary operations illustrated in the block diagram 300 may start at 302A and may be performed by any computing system, apparatus, or device, such as by the system 102 of FIG. 1 or the processor 202 of FIG. 2. Although illustrated with discrete blocks, the exemplary operations associated with one or more blocks of the block diagram 300 may be divided into additional blocks, combined into fewer blocks, or eliminated, depending on the particular implementation.

In an embodiment, a user 306 of the first vehicle 112A may be planning to navigate from a first location (say his/her home) to a second location (say his/her office) using the first vehicle 112A. The exemplary operations from 302A to 302I may be executed as soon as an ignition of the first vehicle 112A may be turned on or the first vehicle 112A starts moving. In another embodiment, the exemplary operations from 302A to 302I may be executed based on a reception of a user input from the user 306 of the first vehicle 112A via an input device (say via a button installed in the first vehicle 112A).

At 302A, a first probe data acquisition operation may be executed. In the first probe data acquisition operation, the system 102 may be configured to obtain the first probe data 114 that may be associated with the plurality of probe points. The first probe data 114 may be obtained from the first vehicle 112A of the set of vehicles 112 travelling on the road segment 106. In an embodiment, the first probe data 114 associated with each probe point of the plurality of points may include, such as, but not limited to, the speed information of the first vehicle 112A at the corresponding probe point, the location information 114B at the corresponding probe point, and the timestamp 114C associated with the corresponding probe point.

In an exemplary embodiment, considering the first vehicle 112A may be at point “A” at timestamp “T1”. Further, the first vehicle 112A may move to point “B” at timestamp “T2”. In this case, the first probe data 114 may include the speed and the location of the first vehicle 112A at timestamp “T1”. The first probe data 114 may further include the speed and the location of the first vehicle 112A at timestamp “T2”. The system 102 may be further configured to estimate an accelerator metric based on the obtained first probe data 114.

At 302B, an accelerator metric estimation operation may be executed. In the accelerator metric estimation operation, the system 102 may be configured to estimate a first accelerator metric associated with the first vehicle 112A based on the obtained first probe data 114. Specifically, the system 102 may be configured to estimate the accelerator metric based on the speed information included in the first probe data 114. For example, the system 102 may determine the difference between the speed information 114A associated with the first vehicle 112A of the set of vehicles 112 at point “A” and point “B” to estimate the first accelerator metric associated with the first vehicle 112A.

In an embodiment, the system 102 may be configured to determine the first speed of the first vehicle 112A at the first timestamp “T1” from the first probe data 114. The first timestamp may be associated with the first probe point within the set of probe points. Further, the system 102 may be further configured to determine a second speed of the first vehicle 112A at the second timestamp “T2” from the first probe data 114. The second timestamp may be associated with a second probe point within the set of probe points. The system 102 may be further configured to estimate the first accelerator metric associated with the first vehicle 112A based on the determined first speed and the determined second speed as described below.

For example, if the speed information 114A associated with the first vehicle 112A at point “A” at time “T1” is for example, but not limited to, 20 km/h and the speed information 114A associated with the first vehicle 112A at point “B” at the time “T2” is for example, but not limited to, 30 km/h, then the system 102 may determine the difference between the speed information 114A associated with the first vehicle at point “A” and point “B”. The difference may be, for example, 10 km/h². The determined difference is the acceleration of the first vehicle 112A from the point “A” to the point “B” over time “T1” to “T2”.

In an exemplary embodiment, if the determined first speed of the first vehicle at time “T1” may be “P1” and the determined second speed of the first vehicle at time “T2” may be “P2”, the system 102 may estimate the first accelerator metric by determining the acceleration of the first vehicle 112A by using equation (1) below:

$$A [ T 2 ] = P 2 ( T 2 ) - P 1 ( T 2 - x ) \qquad ( 1 )$$

Where:
A indicates accelerator metric,
P1 and P2 indicate the position of the first vehicle 112A,
T2 indicates time, and
x is an integer and depends on the frequency of probe point and may be for example, but not limited to, 1, 2, 3, 10, 20, 30, 100, 200, 300.

The estimated accelerator metric may provide insight into the rate of change of speeds, either increasing or decreasing across the length of the congestion queue. An aggregate (multiple vehicles simultaneously) increases in speed or decrease in speed at a particular road segment is one of the key intrinsic activities in a queue that the disclosed method elicits.

At 302C, a motion component generation operation may be executed. The system 102 may be configured to generate the plurality of motion components for each of the first plurality of probe points based on the obtained first probe data 114. In an embodiment, the system 102 may generate the plurality of motion components for the first plurality of probe points based on the obtained first probe data 114 and the estimated first accelerator metric.

In an exemplary embodiment, the first probe data 114 associated with the first vehicle 112A may include the speed information 114A, the location information 114B, and timestamp 114C at various points along the road segment 106. In an embodiment, the system 102 may utilize the first probe data 114 to generate a set of motion components. By incorporating the estimated first accelerator metric, which may be indicative of the acceleration behavior associated with the first vehicle 112A, the system 102 may generate the set of motion components that may provide insights into the speed information 114A of the first vehicle 112A and location change over time.

In an exemplary embodiment, the system 102 may be further configured to generate the motion components of each of the first plurality of probe points on the road segment 106 that may have congestion. To calculate the motion component for each probe point, the system 102 may use equation (2) as mentioned below:

$$M ( p ( t ) , s ( t - 1 ) , a ( t ) ) \qquad ( 2 )$$

Where:
M represents the motion component,
p indicates the position of the first vehicle 112A associated with the corresponding probe point,
s indicates the speed of the first vehicle 112A associated with the corresponding probe point,
a indicates acceleration metric associated with the corresponding probe point, and
t indicates the time associated with the corresponding probe point.

At 302D, a machine learning model application operation may be executed. The system 102 may be configured to apply the ML model 110 on the generated plurality of motion components for the plurality of probe points. In an exemplary embodiment, the ML model 110 may implement an algorithm that may be, for example, but not limited to, a K-means algorithm. The K-means algorithm may be a centroid-based clustering algorithm that may aim to partition data points into K clusters based on their similarity to the cluster centroids. It may further involve iteratively assigning data points (such as the plurality of probe points) to the nearest centroid and updating the centroids to minimize the sum of distances within clusters.

At 302E, a clusters generation operation may be executed. The system 102 may be configured to generate a set of clusters based on the application of the ML model 110 on the generated plurality of motion components. Each probe point may be assigned within one cluster of the set of clusters. In an embodiment, each cluster of the set of clusters may be a group of data points that may be similar to each other based on their relation to surrounding data points. As discussed above, clustering may be a technique that may be used to group objects or data points that may share similarities, allowing for the identification of patterns, relationships, and structures within complex datasets. Each cluster of the set of clusters may be formed based on the inherent characteristics of the data, without the need for labeled information, making it an essential tool for exploratory data analysis and pattern recognition.

In an exemplary embodiment, the number of clusters (“K”), must be specified by the user 306. It may be noted that the selection of the right value of “K” may be crucial for the performance of the K- means algorithm. In another exemplary embodiment, the optimal value of “K” may be determined by using an elbow method. The elbow method may plot the sum of squared errors (SSE) for different values of “K” and look for the point where the SSE starts to level off, indicating the optimal number of clusters.

In an exemplary embodiment, the system 102 may be configured to receive an input associated with a count of the set of cluster. The user input may be received from a user 306 via a user device 304. Based on the application of the ML model 110 on the generated plurality of motion components and the received input, the system 102 may be configured to generate the set of clusters. For example, the user 306 may interact with the system 102 through the user device 304 to provide the user input associated with the count of clusters that may be denoted as the value of “K” in the K-means clustering algorithm. The user 306 may input the desired number of clusters to be generated based on the data and analysis requirements. For example, if the user 306 inputs K=3, the system 102 may apply the ML model 110 to the motion components and output three distinct clusters based on the characteristics and patterns identified in the motion components allowing for the segmentation of the plurality of probe points into the specified number of clusters.

At 302F, a cluster rendering operation may be executed. In the set of clusters output operation, the system 102 may be configured to output the generated set of clusters. In an exemplary embodiment, the generated set of clusters may further help in determining the average acceleration of the set of vehicles associated with the road segment 116. The road segment 106 may be a crucial component in detecting and tracking traffic congestion in urban areas. By analyzing the data collected from road infrastructure sensors, such as RFID data of the set of vehicles, traffic congestion status may be detected for each road segment.

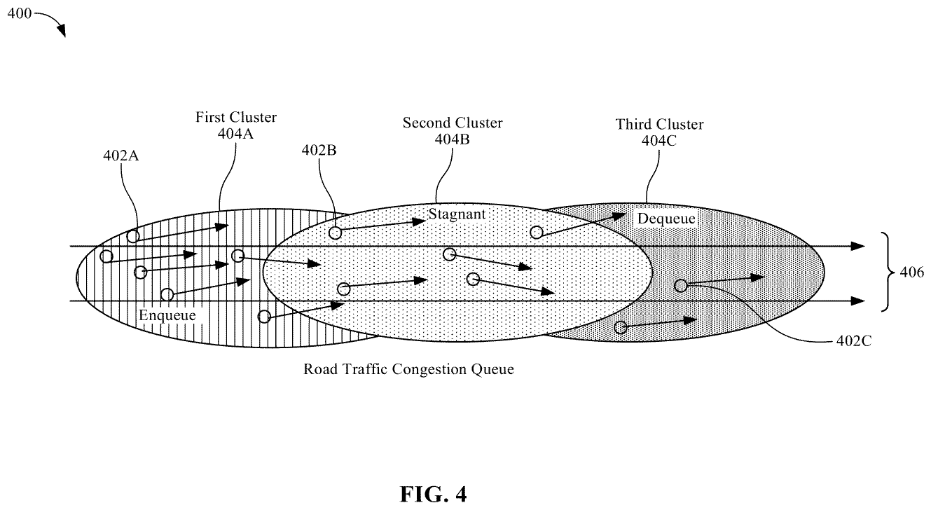

At 302G, an average acceleration determination operation may be executed. The system 102 may be configured to determine the average acceleration of the first set of vehicles of the set of vehicles within the first cluster of the set of clusters. In an exemplary embodiment, based on the number of clusters (“K”) being, for example, 3. The system 102 may determine the average acceleration of the vehicles that may be within the first cluster of the set of 3 clusters. Based on the determined average acceleration, the comparison of the average acceleration may take place. The details about the average acceleration determination are provided in FIG. 4.

At 302H, an average acceleration comparison operation may be executed. The system 102 may be configured to compare the determined average acceleration of the first set of vehicles with a first pre-defined threshold. The first pre-defined threshold may be, for example, but not limited to, 0 km/h², 10 km/h², or 20 km/h².

In an exemplary embodiment, if the average acceleration of the first vehicle 112A in the first cluster of the set of clusters may be less than or equal to 10 km/h², then the determined congestion queue status on the road segment 106 or the first road lane may correspond to enqueuing of the traffic congestion on the corresponding road segment 106 or the first road lane. In another exemplary embodiment, if the average acceleration of the first vehicle 112A in the second cluster of the set of clusters may be greater than 10 km/h² and less than 20 km/h², then the determined congestion queue status on the road segment 106 or the first road lane may correspond to stagnant traffic congestion on the corresponding road segment 106 or the first road lane. In yet another exemplary embodiment, if the average acceleration of the first vehicle 112A in the third cluster of the set of clusters may be greater than or equal to 20 km/h², then the determined congestion queue status on the road segment 106 or the first road lane may correspond to dequeuing of the traffic congestion on the corresponding road segment 106 or the first road lane.

In an alternate embodiment, the first pre-defined threshold for the first cluster of the set of clusters may be the average acceleration of the second set of vehicles of the set of vehicles 112 within the second cluster of the set of clusters. For example, if the average acceleration of the first set of vehicles associated with the set of vehicles 112 in the first cluster of the set of clusters is −14 km/h², and the average acceleration of the second set of vehicles associated with the set of vehicles 112 in the second cluster of the set of clusters is 10 km/h², the system 102 may compare the average acceleration of the first set of vehicles with the average acceleration of the second set of vehicles. The system 102 may determine the traffic congestion status in the first portion of one of the road segments 106 or the road lane based on the comparison. Specifically, the system 102 may determine that the congestion corresponds to dequeuing of the traffic congestion in the first portion of one of the road segments 106 or the road lane as the average acceleration in the second cluster is greater than the average acceleration in the first cluster. Further, in a case, if the average acceleration in the first cluster is greater than the average acceleration in the second cluster, then the system 102 may determine that the congestion corresponds to enqueuing of the traffic congestion in the first portion of one of the road segments or the road lane.

Similarly, the first pre-defined threshold for the second cluster of the set of clusters may be the average acceleration of the third set of vehicles of the set of vehicles 112 within the third cluster of the set of clusters. Further, based on the comparison, the system 102 may be configured to determine the traffic congestion status in the first portion of the road segment.

At 302I, a congestion status determination operation may be executed. In the congestion status determination operation, the system 102 may be configured to determine the traffic congestion status in the first portion of the road segment based on the determined average acceleration. The determined traffic congestion status may correspond to one of an enqueuing of the traffic congestion in the first portion of the road segment, a dequeuing of the traffic congestion in the first portion of the road segment, or stagnant traffic congestion in the first portion of the road segment.

In an embodiment, the enqueuing of the traffic congestion at the first portion of the road segment may be indicative of a buildup of the traffic at the corresponding location on the road segment 106 or road lane. In an embodiment, the enqueuing may occur when the first set of vehicles of the set of vehicles 112 entering the road segment 106 may exceed the capacity of the road, leading to slower speeds and acceleration, increased travel times, and potentially gridlock. Som of the factors that may contribute to enqueuing may include, but are not limited to, high traffic volume, bottlenecks, accidents, road closures, or inefficient traffic flow management.

In another embodiment, the dequeuing of the traffic congestion at the first portion of the road segment may be indicative of a reduction of the traffic at the corresponding location on the road segment 106 or road lane. The dequeuing may help alleviate the negative impacts of congestion, such as, but not limited to, increased travel times, fuel consumption, and air pollution. Additionally, effective dequeuing strategies may further help in reducing the need for costly road expansion projects and promote the use of alternative modes of transportation, such as public transit and active transportation.

In another embodiment, the stagnant traffic congestion in the first portion of the road segment 106 may be indicative of a situation where the traffic comes to a standstill or moves very slowly at the corresponding location on the road segment 106 or road lane due to various factors like high traffic volume, bottlenecks, or inadequate road capacity.

At 302J a congestion status rendering operation may be executed. The system 102 may be configured to perform the congestion status rendering operation. In an embodiment, the system 102 may determine the traffic congestion status and display it on a user device 304 associated with the user 306. In an exemplary embodiment, the user 306 may receive real-time information on traffic conditions, allowing them to plan their routes more efficiently and avoid congested areas. In another exemplary embodiment, the user 306 may get reduced travel time by avoiding congested roads, users may save time and optimize their commute, reducing the amount of time spent in traffic.

FIG. 4 is a diagram that illustrates a scenario diagram depicting a set of clusters on a road segment, in accordance with an embodiment of the disclosure. FIG. 4 is explained in conjunction with elements from FIG. 1, FIG. 2, and FIG. 3. With reference to FIG. 4, there is shown a diagram 400 that includes a first plurality of probe points that may include a first probe point 402A, a second probe point 402B, a third probe point 402C. There is further shown a set of clusters that may include a first cluster 404A, a second cluster 404B, and a third cluster 404C. In an embodiment, the first probe point 402A, the second probe point 402B and the third probe point 402C may be obtained from the first vehicle 112A of the set of vehicles 112 travelling on a road segment 406.

The first probe point 402A may represent the first probe data 114 captured by the first vehicle 112A at time “T1”, the second probe point 402B may represent the first probe data 114 captured by the first vehicle 112A at time “T2”, and the third probe point 402C may represent the first probe data captured by the first vehicle 112A at time “T3”. The first probe data associated with each probe point of the first plurality of probe points may include speed information 114A of the first vehicle 112A at the corresponding probe point, location information 114B of the first vehicle at the corresponding probe point, and timestamp 114C associated with the corresponding probe point.

In another embodiment, the system 102 may be configured to generate the plurality of motion components for each of the first plurality of probe points based on the obtained first probe data 114. In an exemplary embodiment, the system 102 may be configured to generate a variety of motion components for each of the plurality probe points using the obtained first probe data 114. This process involves extracting relevant information from the first probe data 114, such as speed information 114A, location information 114B, and timestamp 114C and transforming the raw first probe data 114 into distinct motion components for each probe point. The motion components provide a more detailed and nuanced representation of the movement characteristics of each probe point, enabling a deeper analysis of the traffic conditions and patterns within the road segment 106. By generating the motion components based on the first probe data 114, the system 102 may enhance its ability to understand and interpret the dynamics of traffic flow, aiding in the identification of congestion, anomalies, or trends within the monitored area.

In yet another embodiment, the system 102 may be configured to determine the first speed of the first vehicle 112A at the first timestamp from the first probe data 114. Further, the first timestamp may be associated with the first probe point 402A of the plurality of probe points. The system 102 may be further configured to determine the second speed of the first vehicle 112A at a second timestamp from the first probe data. The second timestamp may be associated with the second probe point 402B of the plurality of probe points.

Further, the system 102 may be configured to receive an input associated with a count of the set of clusters from the user device 304. In an embodiment, the count of the set of clusters received from the user device 304 may be, for example, but not limited to, 3. The system 102 may be further configured to generate the set of clusters based on the application of the ML model 110 on the generated plurality of motion components and the received input. The ML model 110 may be used to generate the set of clusters by implementing the clustering algorithm. The clustering algorithm may include, for example, but not limited to, the K-means algorithm. In an exemplary embodiment, the K- means algorithm may be used to cluster the probes using K=3. Upon the application of the K-means algorithm, the generated number of clusters may be 3.

In an exemplary embodiment, the system 102 may be further configured to determine a distance between each of the consecutive probe points. Specifically, the system may determine the distance between the motion component associated with the second probe point 402B and the motion component associated with the first probe point 402A. To determine the distance, the system 102 may use equation (3) as provided below:

$$Distance ( M 2 , M 1 ) = \sqrt[2]{{( p 2 - p 1 )}^{2} + {( s 2 - s 1 )}^{2} + {( a 2 - a 1 )}^{2}} \qquad ( 3 )$$

Where:
P(i) corresponds to the position of the vehicle at a probe point “i,”
s(i) corresponds to the speed of the vehicle at a probe point “i,” and
a(i) corresponds to the accelerator metric associated with the probe point “i.”

In an exemplary embodiment, the system 102 may be configured to determine a boundary of each cluster of the set of cluster based on a first variable (maximum(p)) and a second variable (minimum(p)). The maximum(p) and the minimum(p) may be used to set boundaries on the road segment for the various activities happening in terms of traffic and congestion queue status and may be indicative of a maximum and a minimum change in the position of the vehicle over a period of time. In an embodiment, the boundaries in the K-Means clustering algorithm may be the edges or limits of each cluster. The edges of each cluster may define an area where the data points such as, the plurality of probe points may be assigned. The boundaries may be determined by the distance of each of the plurality of probe points to the centroid of the corresponding clusters. The K-Means algorithm may iteratively assign probe points to the closest centroid and update the centroid's position based on the average of the plurality of probe points within the corresponding cluster. The boundary of each cluster may be defined by the decision boundary, which may be a line or a surface that separates the clusters based on the maximum(p) and minimum(p) of the centroids in each of the clusters.

In an embodiment, based on the determined boundaries, the system 102 may generate a set of clusters such as the first cluster 404A, the second cluster 404B, and the third cluster 404C. In an exemplary embodiment, the first cluster 404A associated with the set of clusters may correspond to the enqueuing of the traffic congestion in the set of vehicles 112 within the first cluster 404A. The enqueuing of the traffic congestion may be the buildup of traffic within the first cluster 404A. The second cluster 404B associated with the set of clusters may correspond to the stagnant traffic congestion of the road segment 106. The stagnant traffic congestion may be a state of prolonged traffic congestion where the set of vehicles 112 within the second cluster 404B are unable to move or move at a slow pace for an extended period. The stagnant traffic congestion may often be caused by factors such as, but not limited to, high traffic demand, road incidents, roadworks, or insufficient road capacity. In another exemplary embodiment, the third cluster 404C of the set of clusters may correspond to the dequeuing of the traffic congestion on the road segment 106. The dequeuing traffic congestion status on the road segment may be the process of reduction in traffic congestion in the set of vehicles 112 within the third cluster 404C of the road segment 106.

In an embodiment, upon determining the boundaries of the each of the set of clusters, the system 102 may be configured to determine an average acceleration of the first set of vehicles of the set of vehicles 112 within a first cluster 404A of the set of clusters. The average acceleration may be a change in speed of the first vehicle 112A over a given period. The average acceleration may be determined as the difference between the speed information 114A of the first vehicle at point “B” and the speed information 114A of the first vehicle at point “A” divided by the time over which the change occurs.

Further, the system 102 may be configured to compare the determined average acceleration of the first set of vehicles with a pre-defined threshold. In a case, where the average acceleration for the first cluster 404A may be less than the average acceleration of the second cluster 404B and the average acceleration of the second cluster may be less than the average acceleration of the third cluster 404C then the determined traffic congestion status in the first portion of the road segment may correspond to dequeuing of the traffic congestion. The dequeue status may signify that the congestion may be reducing. In a case where the average acceleration of the third cluster 404C may be less than 0 hm/h², then the determined traffic congestion status in the first portion of the road segment 106 may correspond to the enqueuing of the traffic congestion in the first portion of the road segment 106. The system 102 may be further configured to output the determined traffic congestion status on the road segment.

In an exemplary embodiment, the average acceleration may help in coloring the road segment in terms of the Level of Service (LOS), the degree of the congestion, and the representative traffic speed for that first portion of the road segment. Further, the K value may be different especially when the area of congestion is undefined (i.e. not sure if there is congestion or where congestion is) then the K value may be, for example, K>3 such that all other non-congestion segments of the roads are also captured and then only the clusters with average acceleration equal to congestion speed may be regarded as clusters of probes in congestion, and then the minimum(p) and maximum(p) helps to define the subsegment of the road with congestion.

The system 102 may apply the MIL model 110 run every time ‘t’ epoch and the system 102 may be further configured to publish the properties of the emergent clusters. The congestion queue status determined by the system 102 using the properties of the emergent clusters may be published by a traffic service provider (TSP) and consumed in real-time by, for example, but not limited to, forecasting algorithms, traffic engineers, traffic visualization, etc.

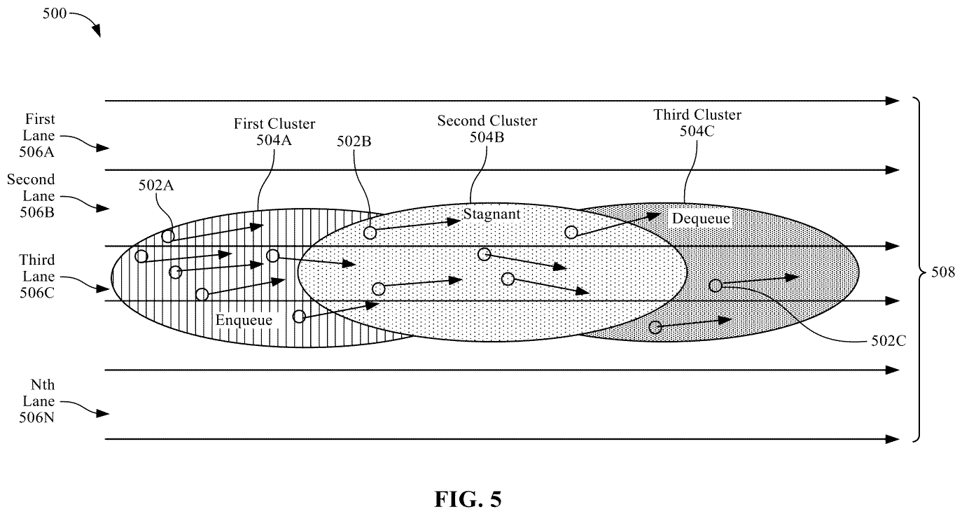

FIG. 5 is a diagram that illustrates a scenario depicting a set of clusters in a lane of a road segment, in accordance with an embodiment of the disclosure. FIG. 5 is explained in conjunction with elements from FIG. 1, FIG. 2, FIG. 3, and FIG. 4. With reference to FIG. 5, there is shown the diagram 500 that includes a first probe point 502A, a second probe point 502B, a third probe point 502C, a first cluster 504A, a second cluster 504B, a third cluster 504C. In FIG. 5, there is further shown a set of lanes 506 of a road segment 508. The set of road lanes may include a first lane 506A, a second lane 506B, a third lane 506C, up to Nth Lane 506N.

In an embodiment, the system 102 may determine traffic congestion status on a road lane (or a lane) of the set of lanes of a road segment 508. Such determination of the traffic congestion status on the road lane may allow for a more precise measurement of congestion levels on the road segment 508. The road lane is a narrower and specific area of the road, which means that traffic congestion can be measured more accurately within that lane. Such determination may help to identify specific areas of congestion and to develop targeted solutions to address those issues.

In an embodiment, the first probe point 502A, the second probe point 502B, and the third probe point 502C may be associated with the first vehicle 112A of the set of vehicles 112 associated with the first lane 506A of the set of lanes 506 within the road segment 508. The first probe point 502A may represent the first probe data 114 of the first vehicle 112A at time “T1”. The second probe point 502B may represent the first probe data 114 of the first vehicle 112A at time “T2”, and the third probe point 502C may represent the first probe data 114 of the first vehicle 112A at time “T3”. The first probe data 114 associated with each probe point of the first plurality of probe points may include speed information 114A of the first vehicle 112A at the corresponding probe point, location information 114B of the first vehicle 112A at the corresponding probe point, and timestamp 114C associated with the corresponding probe point. The timestamp 114C may represent the time at which the first probe data 114 may be obtained. The system 102 may be configured to generate the plurality of motion components for each of the first plurality of probe points based on the obtained first probe data 114. Details about the generation of motion components are provided, for example, in FIGS. 3 and 4.

Further, the system 102 may be configured to determine the first speed of the first vehicle 112A at the first timestamp from the first probe data 114. Further, the first timestamp may be associated with the first probe point 502A of the plurality of probe points. The system 102 may be further configured to determine the second speed of the first vehicle 112A at a second timestamp from the first probe data. The second timestamp may be associated with the second probe point 502B of the plurality of probe points.

Further, the system 102 may be configured to estimate the first accelerator metric associated with the first vehicle based on the determined first speed and the determined second speed. In an exemplary embodiment, if the determined first speed of the first vehicle at time “T1” may be “P1” and the determined second speed of the first vehicle at time “T2” may be “P2”, the system 102 may estimate the first accelerator metric. The details of the determination of the accelerator metric are provided in FIG. 3.

The system 102 may be further configured to generate the set of clusters 504 for the first lane 506A of the set of lanes 506 based on the estimated accelerator metrics. In an embodiment, the first cluster 504A of the set of clusters may correspond to the enqueuing of the traffic congestion in the set of vehicles 112 within the first cluster 504A. The enqueuing of the traffic congestion may be the buildup of traffic in the set of vehicles 112 within the first cluster 504A of the set of vehicles 112. The second cluster 504B associated with the set of clusters may correspond to the stagnant traffic congestion of the road segment 106. The stagnant traffic congestion may be a state of prolonged traffic congestion where the set of vehicles 112 within the second cluster 504B are unable to move or move at a slow pace for an extended period. The stagnant traffic congestion may often be caused by factors such as, but not limited to, high traffic demand, road incidents, roadworks, or insufficient road capacity. In another exemplary embodiment, the third cluster 504C associated with the set of clusters may correspond to the dequeuing of the traffic congestion on the road segment 106. The dequeuing traffic congestion status on the road segment may be the process of reduction in traffic congestion in the set of vehicles 112 within the third cluster 404C of the road segment 106.

In a case where the average acceleration for the first cluster 504A may be less than the average acceleration of the second cluster 504B and the average acceleration of the second cluster may be less than the average acceleration of the third cluster 504C, then the determined traffic congestion status in the first lane 506A of the set of lanes 506 within the road segment 508 may correspond to dequeuing of the traffic congestion. The dequeue status may signify that the congestion may be reducing. In a case where the average acceleration of the third cluster may be less than 0, then the determined traffic congestion status in the first lane of the set of lanes within the road segment 106 may correspond to the enqueuing of the traffic congestion. The first lane may be, for example, the third lane 506C.

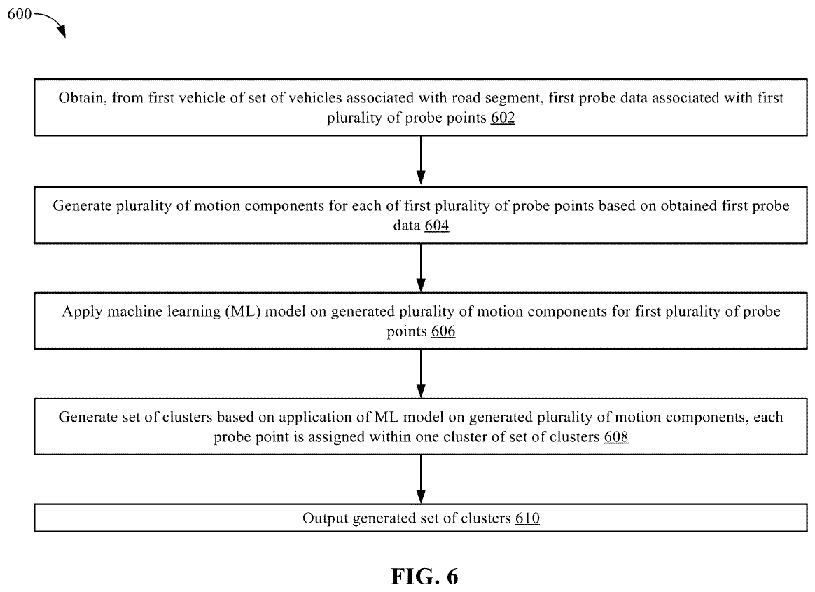

FIG. 6 is a flowchart 600 that illustrates an exemplary method for characterizing congestion queue status on road links, in accordance with an embodiment of the disclosure. FIG. 6 is explained in conjunction with elements from FIGS. 1, 2, 3, 4, and 5. With reference to FIG. 6, there is shown the flowchart 600. The operations of the exemplary method may be executed by any computing system, for example, by the system 102 of FIG. 1 or the processor 202 of FIG. 2. The operations of the flowchart 600 may start at 602.

At 602, the first probe data 114 associated with the first plurality of probe points may be obtained from the first vehicle 112A of the set of vehicles 112 associated with the road segment 106. In an embodiment, the one or more processors 202 may be configured to obtain, from the first vehicle 112A of the set of vehicles 112 associated with the road segment 106, the first probe data 114 associated with the first plurality of the probe points. Details about the first probe data 114 are provided in FIG. 1.

At 604, a plurality of motion components for each of the first plurality of probe points may be generated based on the obtained first probe data 114. In an embodiment, the one or more processors 202 may be configured to generate the plurality of motion components for each of the first plurality of probe points based on the obtained first probe data 114. Details about the motion components are provided in FIG. 3.

At 606, the ML model 110 may be applied to the generated plurality of motion components for the first plurality of probe points. In an embodiment, the one or more processors 202 may be configured to apply the ML model 110 on the generated plurality of motion components for the first plurality of probe points. Details about the machine learning model are provided in FIG. 3.

At 608, the set of clusters may be generated based on the application of the ML model 110 on the generated plurality of motion components. Each of the probe points may be assigned within one cluster of the set of clusters. In an embodiment, the one or more processors 202 may be configured to generate the set of clusters based on the application of the ML model 110 on the generated plurality of motion components. Each of the probe points may be assigned within one cluster of the set of clusters. Details about the set of clusters are provided in0020 FIG. 3, FIG. 4, and FIG. 5.

At 610, the generated set of clusters may be output. In an embodiment, the one or more processors may be configured to output the generated set of clusters. Details about the output of the set of clusters are provided in FIG. 4 and FIG. 5.

Accordingly, blocks of the flowchart 600 support combinations of means for performing the specified functions and combinations of operations for performing the specified functions. It will also be understood that one or more blocks of the flowchart 600 can be implemented by special-purpose hardware-based computer systems which perform the specified functions, or combinations of special-purpose hardware and computer instructions.

Alternatively, the system 102 may comprise means for performing each of the operations described above. In this regard, according to an example embodiment, examples of means for performing operations may comprise, for example, the processor 202 and/or a device or circuit for executing instructions or executing an algorithm for processing information as described above.

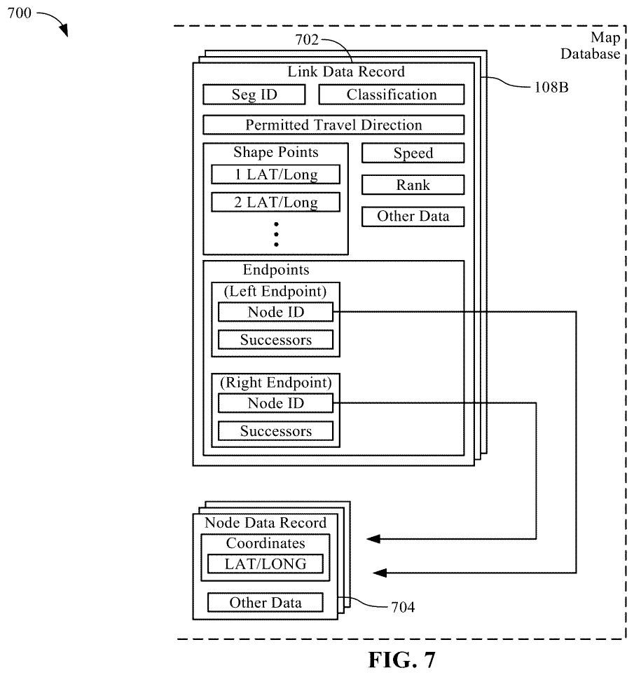

FIG. 7 shows the first format of the map data 700 stored in the map database 108B according to one or more example embodiments. FIG. 7 shows a link data record 702 that may be used to store data about one or more of the feature lines. This link data record 702 has information (such as “attributes”, “fields”, etc.) associated with it that allows identification of the nodes associated with the link and/or the geographic positions (e.g., the latitude and longitude coordinates and/or altitude or elevation) of the two nodes. In addition, the link data record 702 may have information (e.g., more “attributes”, “fields”, etc.) associated with it that specify the permitted speed of travel on the portion of the road represented by the link record, the direction of travel permitted on the road portion represented by the link record, what, if any, turn restrictions exist at each of the nodes which correspond to intersections at the ends of the road portion represented by the link record, the street address ranges of the roadway portion represented by the link record, the name of the road, and so on. The various attributes associated with a link may be included in a single data record or are included in more than one type of record which are referenced to each other.

Each link data record that represents another-than-straight road segment may include shape point data. A shape point is a location along a link between its endpoints. To represent the shape of other-than-straight roads, the mapping platform 108 and its associated map database developer select one or more shape points along the other-than-straight road portion. Shape point data included in the link data record 702 indicates the position, (e.g., latitude, longitude, and optionally, altitude or elevation) of the selected shape points along the represented link.

Additionally, in the compiled geographic database (or map database), such as a copy of the map database 108B, there may also be a node data record 704 for each node. The node data record 704 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases (or map databases) are organized to facilitate the performance of various navigation-related functions. One way to facilitate the performance of navigation-related functions is to provide separate collections or subsets of the geographic data for use by specific navigation-related functions. Each such separate collection includes the data and attributes needed for performing the particular associated function but excludes data and attributes that are not needed for performing the function. Thus, the map data may be alternately stored in a format suitable for performing types of navigation functions, and further may be provided on-demand, depending on the type of navigation function.

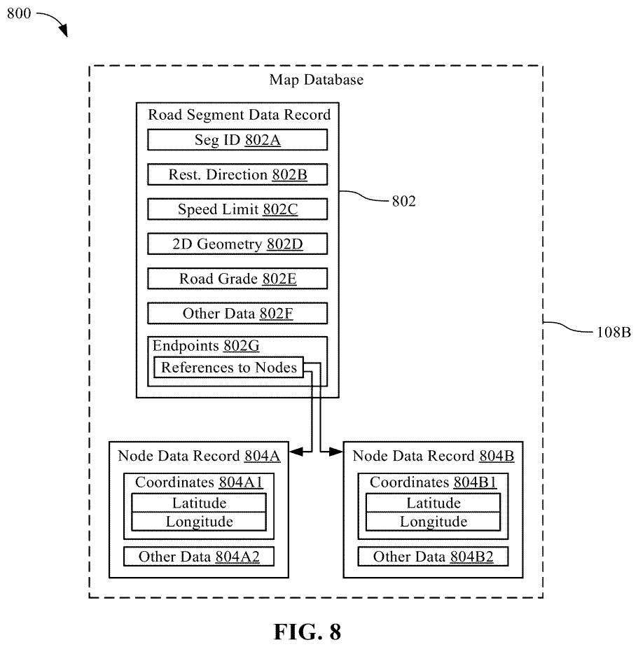

FIG. 8 shows a second format of the map data 800 stored in the map database 108B according to one or more example embodiments. In the FIG. 8, the map data 800 is stored by specifying a road segment data record 802. The road segment data record 802 is configured to represent data that represents a road network. In FIG. 8, the map database 108B contains at least one road segment data record 802 (also referred to as “entity” or “entry”) for each road segment in a geographic region.

The map database 108B that represents the geographic region of FIG. 2 also includes a database record 804 (a node data record 804A and a node data record 804B) (or “entity” or “entry”) for each node associated with the at least one road segment shown by the road segment data record 802. (The terms “nodes” and “segments” represent only one terminology for describing these physical geographic features and other terminology for describing these features is intended to be encompassed within the scope of these concepts). Each of the node data records 804A and 804B may have associated information (such as “attributes”, “fields”, etc.) that allows identification of the road segment(s) that connect to it and/or its geographic position (e.g., its latitude and longitude coordinates).

FIG. 8 shows some of the components of the road segment data record 802 contained in the map database 108B. The road segment data record 802 includes a segment ID 802A by which the data record can be identified in the map database 108B. Each road segment data record 802 has associated with it information (such as “attributes”, “fields”, etc.) that describes features of the represented road segment. The road segment data record 802 may include data 802B that indicate the restrictions, if any, on the direction of vehicular travel permitted on the represented road segment. The road segment data record 802 includes data 802C that indicates a static speed limit or speed category (i.e., a range indicating a maximum permitted vehicular speed of travel) on the represented road segment. The static speed limit is a term used for speed limits with a permanent character, even if they are variable in a pre-determined way, such as dependent on the time of the day or weather. The static speed limit is the sign-posted explicit speed limit for the road segment or the non-sign-posted implicit general speed limit based on legislation.

The road segment data record 802 may also include data 802D indicating the two-dimensional (“2D”) geometry or shape of the road segment. If a road segment is straight, its shape can be represented by identifying its endpoints or nodes. However, if a road segment is other than straight, additional information is required to indicate the shape of the road. One way to represent the shape of an other-than-straight road segment is to use shape points. Shape points are points through which a road segment passes between its endpoints. By providing the latitude and longitude coordinates of one or more shape points, the shape of an other-than-straight road segment can be represented. Another way of representing other-than-straight road segments is with mathematical expressions, such as polynomial splines.

The road segment data record 802 also includes road grade data 802E which indicates the grade or slope of the road segment. In one embodiment, the road grade data 802E includes road grade change points and a corresponding percentage of grade change. Additionally, the road grade data 802E may include the corresponding percentage of grade change for both directions of a bi-directional road segment. The location of the road grade change point is represented as a position along the road segment, such as thirty feet from the end or node of the road segment. For example, the road segment may have an initial road grade associated with its beginning node. The road grade change point indicates the position on the road segment wherein the road grade or slope changes, and the percentage of grade change indicates a percentage increase or decrease of the grade or slope. Each road segment may have several grade change points depending on the geometry of the road segment. In another embodiment, the road grade data 802E includes the road grade change points and an actual road grade value for the portion of the road segment after the road grade change point until the next road grade change point or end node. In a further embodiment, the road grade data 802E includes elevation data at the road grade change points and nodes. In an alternative embodiment, the road grade data 802E is an elevation model that may be used to determine the slope of the road segment.

The road segment data record 802 also includes data 802G providing the geographic coordinates (e.g., the latitude and longitude) of the endpoints of the represented road segment. In one embodiment, the data 802G are references to the node data records 802 that represent the nodes corresponding to the endpoints of the represented road segment.

The road segment data record 802 may also include or be associated with other data 802F that refer to various other attributes of the represented road segment. The various attributes associated with a road segment may be included in a single road segment record or may be included in more than one type of record which cross-reference each other. For example, the road segment data record 802 may include data identifying the name or names by which the represented road segment is known, the street address ranges along the represented road segment, and so on.

FIG. 8 also shows some of the components of the node data record 804 contained in the map database 108B. Each of the node data records 804 may have associated information (such as “attributes”, “fields”, etc.) that allows identification of the road segment(s) that connect to it and/or it is geographic position (e.g., its latitude and longitude coordinates). For the embodiment shown in FIG. 8, the node data records 804A and 804B include the latitude and longitude coordinates 804A1 and 804A1 for their nodes. The node data records 804A and 804B may also include other data 804A2 and 804B2 that refer to various other attributes of the nodes.

Thus, the overall data stored in the map database 108B may be organized in the form of different layers for greater detail, clarity, and precision. Specifically, in the case of high-definition maps, the map data may be organized, stored, sorted, and accessed in the form of three or more layers. These layers may include the road level layer, lane level layer, and localization layer. The data stored in the map database 108B in the formats shown in FIGS. 7 and 8 may be combined in a suitable manner to provide these three or more layers of information. In some embodiments, there may be a lesser or fewer number of layers of data also possible, without deviating from the scope of the present disclosure.

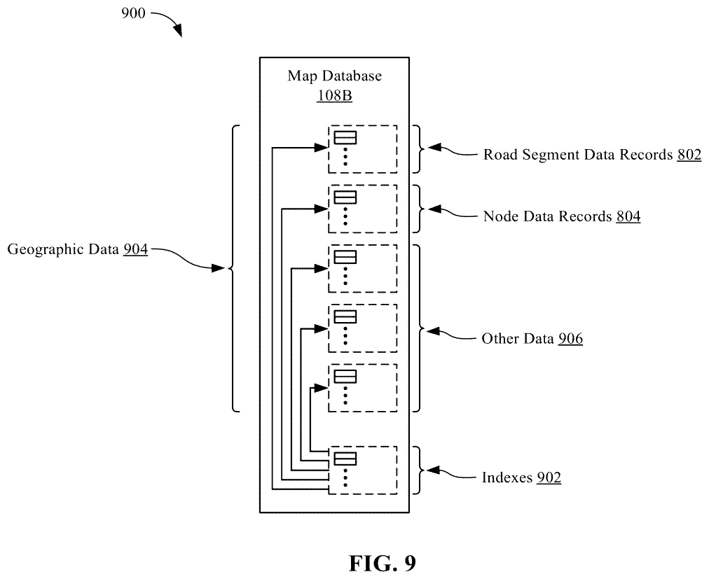

FIG. 9 illustrates a block diagram 900 of the map database 108B storing map data or geographic data 904 in the form of road segments/links, nodes, and one or more associated attributes as discussed above. Furthermore, attributes may refer to features or data layers associated with the link-node database, such as an HD lane data layer.

In addition, the map data 904 may also include other kinds of data 906. The other kinds of data 906 may represent other kinds of geographic features or anything else. The other kinds of data may include point of interest data. For example, the point of interest data may include point of interest records comprising a type (e.g., the type of point of interest, such as restaurant, ATM, etc.), location of the point of interest, a phone number, hours of operation, etc. The map database 108B also includes indexes 902. Indices 902 may include distinct types of indexes that relate the several types of data to each other or that relate to other aspects of the data contained in the map database 108B.

The data stored in the map database 108B in the various formats discussed above may help in providing precise data for high-definition mapping applications, autonomous vehicle navigation and guidance, cruise control using ADAS, direction control using accurate vehicle maneuvering and other such services. In some embodiments, the system 101 accesses the map database 108B storing data in the form of various layers and formats depicted in FIG. 7, FIG. 8, and FIG. 9.

Various embodiments of the disclosure may provide a non-transitory computer readable medium having stored thereon computer executable instructions, which when executed by one or more processors (such as the processor 202), cause the one or more processors to carry out operations to operate a system (e.g., the system 102) for characterizing congestion queue status on road links. The operations include obtaining, from the first vehicle of a set of vehicles associated with a road segment, the first probe data associated with a first plurality of probe points. The operations further include generating a plurality of motion components for each of the first plurality of probe points based on the obtained first probe data. Further, the operations include applying a machine learning (ML) model on the generated plurality of motion components for the first plurality of probe points. The operations further include generating a set of clusters based on the application of the ML model on the generated plurality of motion components. Each probe point may be assigned within one cluster of the set of clusters. Further, the operations include outputting the generated set of clusters.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system configured to:
a memory configured to store a computer-executable instruction; and
one or more processors coupled to the memory, wherein the one or more processors are configured to:
obtain, from a first vehicle of a set of vehicles associated with a road segment, first probe data associated with a first plurality of probe points;
generate a plurality of motion components for each of the first plurality of probe points based on the obtained first probe data;
apply a machine learning (ML) model on the generated plurality of motion components for the first plurality of probe points;
generate a set of clusters based on the application of the ML model on the generated plurality of motion components, wherein each probe point is assigned within one cluster of the set of clusters; and
output the generated set of clusters.

2. The system of claim 1, wherein the one or more processors are further configured to:
determine traffic congestion status on the road segment based on the generated set of clusters; and
output the determined traffic congestion status on the road segment.

3. The system of claim 2, wherein the determined traffic congestion status on the road segment corresponds to one of: an enqueuing of a traffic congestion on the road segment, a dequeuing of the traffic congestion on the road segment, or stagnant traffic congestion on the road segment.

4. The system of claim 1, wherein the first probe data associated with each probe point of the first plurality of probe points comprises of: speed information of the first vehicle at the corresponding probe point, location information of the first vehicle at the corresponding probe point, and timestamp associated with the corresponding probe point.

5. The system of claim 1, wherein the first vehicle is associated with a first lane of a set of lanes within the road segment, and wherein the one or more processors are further configured to:
determine traffic congestion status on the first lane based on the generated set of clusters; and
output the determined traffic congestion status on the first lane, wherein the determined traffic congestion status on the first lane corresponds to one of: an enqueuing of the traffic congestion on the first lane, a dequeuing of the traffic congestion on the first lane, or stagnant traffic congestion on the first lane.

6. The system of claim 1, wherein the one or more processors are further configured to:
receive, from a user device, an input associated with a count of the set of clusters; and
generate the set of clusters based on the application of the ML model on the generated plurality of motion components and the received input.

7. The system of claim 1, wherein the one or more processors are further configured to:
determine an average acceleration of a first set of vehicles of the set of vehicles within a first cluster of the set of clusters; and
determine a traffic congestion status in a first portion of the road segment based on the determined average acceleration, wherein the determined traffic congestion status corresponds to one of: an enqueuing of a traffic congestion in the first portion of the road segment, a dequeuing of the traffic congestion in the first portion of the road segment, or stagnant traffic congestion in the first portion of the road segment.

8. The system of claim 7, wherein the one or more processors are further configured to:
compare the determined average acceleration of the first set of vehicles with a first pre-defined threshold; and
determine the traffic congestion status in the first portion of the road segment based on the comparison.

9. The system of claim 1, wherein the one or more processors are further configured to:
estimate a first accelerator metric associated with the first vehicle based on the obtained first probe data; and
generate the plurality of motion components for the first plurality of probe points based on the obtained first probe data and the estimated first accelerator metric.

10. The system of claim 9, wherein the one or more processors are further configured to:
determine a first speed of the first vehicle at a first timestamp from the first probe data, wherein a first timestamp is associated with a first probe point of the plurality of probe points;
determine a second speed of the first vehicle at a second timestamp from the first probe data, wherein the second timestamp is associated with a second probe point of the plurality of probe points; and
estimate the first accelerator metric associated with the first vehicle based on the determined first speed and the determined second speed.

11. The system of claim 1, wherein the first probe data is captured using one or more sensors associated with the first vehicle, and wherein the one or more sensors comprises at least one of: a Global Navigation Satellite System (GNSS) sensor, or a speed sensor.

12. The system of claim 1, wherein the one or more processors are further configured to store the first probe data and the generated set of clusters for the first probe data in one or more databases.

13. A method comprising:
obtaining, from a first vehicle of a set of vehicles associated with a road segment, first probe data associated with a first plurality of probe points;
generating a plurality of motion components for each of the first plurality of probe points based on the obtained first probe data;
applying a machine learning (ML) model on the generated plurality of motion components for the first plurality of probe points;
generating a set of clusters based on the application of the ML model on the generated plurality of motion components, wherein each probe point is assigned within one cluster of the set of clusters; and
outputting the generated set of clusters.

14. The method of claim 13, further comprising:
determining traffic congestion status on the road segment based on the generated set of clusters; and
outputting the determined traffic congestion status on the road segment.

15. The method of claim 14, wherein the determined traffic congestion status on the road segment corresponds to one of: an enqueuing of a traffic congestion on the road segment, a dequeuing of the traffic congestion on the road segment, or stagnant traffic congestion on the road segment.

16. The method of claim 13, wherein the first probe data associated with each probe point of the first plurality of probe points comprises of: speed information of the first vehicle at the corresponding probe point, location information of the first vehicle at the corresponding probe point, and timestamp associated with the corresponding probe point.

17. The method of claim 13, further comprising:
receiving, from a user device, an input associated with a count of the set of clusters; and
generating the set of clusters based on the application of the ML model on the generated plurality of motion components and the received input.

18. The method of claim 13, further comprising:
determining an average acceleration of a first set of vehicles of the set of vehicles within a first cluster of the set of clusters; and
determining a traffic congestion status in a first portion of the road segment based on the determined average acceleration, wherein the determined traffic congestion status corresponds to one of: an enqueuing of a traffic congestion in the first portion of the road segment, a dequeuing of the traffic congestion in the first portion of the road segment, or stagnant traffic congestion in the first portion of the road segment.

19. The method of claim 13, further comprising:
determining traffic congestion status on a first lane based on the generated set of clusters, wherein the first vehicle is associated with the first lane of a set of lanes within the road segment; and
outputting the determined traffic congestion status on the first lane, wherein the determined traffic congestion status on the first lane corresponds to one of: an enqueuing of the traffic congestion on the first lane, a dequeuing of the traffic congestion on the first lane, or stagnant traffic congestion on the first lane.

20. A computer programmable product comprising a non-transitory computer readable medium having stored thereon computer executable instructions, which when executed by one or more processors, cause the one or more processors to conduct operations comprising:
obtaining, from a first vehicle of a set of vehicles associated with a road segment, first probe data associated with a first plurality of probe points;
generating a plurality of motion components for each of the first plurality of probe points based on the obtained first probe data;
applying a machine learning (ML) model on the generated plurality of motion components for the first plurality of probe points;
generating a set of clusters based on the application of the ML model on the generated plurality of motion components, wherein each probe point is assigned within one cluster of the set of clusters; and
outputting the generated set of clusters.
